(19) United States
(12) Patent Application Publication
(10) Pub. No.: US 2003/0177660 A1
(43) Pub. Date: Sep. 25, 2003

(54) Device for drying paper webs, especially tissue paper webs

(76) Inventors: Wolfgang Promitzer, Graz (AT); Johann Hiebaum, Kalsdorf (AT)

Correspondence Address: Alix, Yale & Ristas, LLP, Suite 1400, 750 Main Street, Hartford, CT, 06103-2721, US

(21) Appl. No.: 10/392,460

(22) Filed: Mar. 19, 2003

(30) Foreign Application Priority Data
Mar. 19, 2002 (AT) A 411/2002

(51) Int. Cl. F26B 9/00; F26B 13/00; F26B 13/06

(52) U.S. Cl. 34/623; 34/618; 34/611

(57) ABSTRACT

The invention relates to a device for drying paper webs, especially tissue paper webs, with a dryer cylinder 1 and a dryer hood 2, 3 for blowing hot air onto the paper web. It is mainly characterised by the inlet air parts of the dryer hood 2, 3, such as the nozzle basket 9 or the inlet duct 4, being uncoupled from the frame or hood structure 10. This is especially advantageous at operating temperatures of up to 700° C.

### BACKGROUND OF THE INVENTION

The invention relates to a device for drying paper webs, especially tissue paper webs, with a dryer cylinder and a dryer hood for blowing hot air onto the paper web.

These systems are also called Yankee cylinders (dryers) and Yankee hoods and have been used in the area of tissue production for a long time. High impingement temperatures of the hot air are required in order to achieve high throughput and good quality. Currently, dryer hoods working at temperatures of up to approx. 500° C. are in operation, with limitations that are due primarily to the materials. There are drawbacks, caused especially also by different gaps between the dryer cylinder and the dryer hood during operation, leading to non-uniform drying.

### SUMMARY OF THE INVENTION

The aim of the invention is therefore to provide a device for efficient, uniform drying of a paper web, especially a tissue paper web, at high temperatures.

According to the invention this is achieved by uncoupling the inlet air parts of the dryer hood, such as the nozzle basket or the inlet duct, from the frame or hood structure. This uncoupling e.g., flexible connection, makes free movement of the hot parts, like the nozzle basket and the inlet duct, possible.

If the nozzle basket is pivotably mounted at an upper point in the frame, then the nozzle basket can move freely while it warms up and cools off, and no stresses are created.

If the nozzle basket is supported for sliding at a lower point of the hood frame, with the lower support point possibly being optionally adjustable, a uniform and optionally adjustable gap can be achieved between the cylinder and the hood.

If the frame and the nozzle basket are fixed advantageously at different sides (drive side and front side, respectively) perpendicular to the paper web, expansion perpendicular to the paper web can be minimized.

If an additional adjustment option for the gap between the dryer cylinder and the dryer hood is to be achieved in operation, a drive unit and a gap sensor are provided according to the invention.

It is particularly advantageous for the gap between the dryer hood and the dryer cylinder to be essentially uniform at all points at high impingement temperatures in operation, especially above 550° C., and for instance up to 700° C.

### BRIEF DESCRIPTION OF THE DRAWINGS

The preferred embodiment of the invention will be described below with reference to the accompanying drawings, where:

FIG. 1 shows a schematic overview of a dryer with dryer cylinder and dryer hood;

FIG. 2 shows one hood half in the cold state;

FIG. 3 shows a hood half analogous to FIG. 2 but with hot nozzle basket;

FIG. 4 shows an analogous view with hot hood half and hot hood frame;

FIG. 5 shows the area of a support for the hood; and

FIG. 6 shows the area of another support of the hood.

### DESCRIPTION OF THE PREFERRED EMBODIMENT

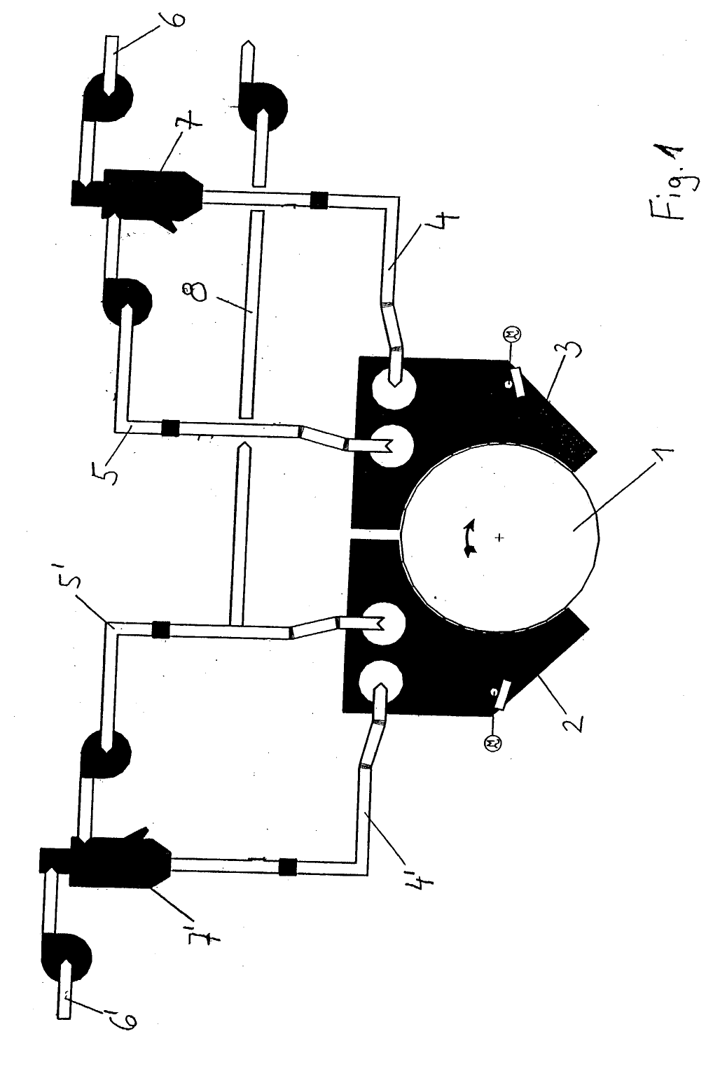

FIG. 1 shows the schematic construction of a drying system for paper, especially tissue paper as viewed from the front side (with the drive side at the opposite axial end). The paper web is guided around a dryer cylinder 1, which is partially wrapped or enveloped by a first hood half 2 and a second hood half 3. Hot air from a duct 4, 4′ is blown through the hoods onto the paper. The cooled-off air is discharged through a duct 5, 5′. Currently, the hot air temperatures are between 300° C. and 500° C., which gives a water evaporation of approximately 90 kg_{w}/m²h and 160 kg_{w}/m²h, respectively. The goal is, however, to increase the impingement temperature to 600° C. and 700° C., respectively, which gives water evaporation rates of over 200 kg_{w}/m²h. At these high temperatures, however, undesired geometric relationships arise as the hood expands under the heat. Thus, the gap between dryer cylinder 1 and hood 2, 3 changes to the extent that larger gaps are created at the lower end, while at the upper end, the hood parts 2, 3 may grind against cylinder 1 and may damage both the paper web and the cylinder 1.

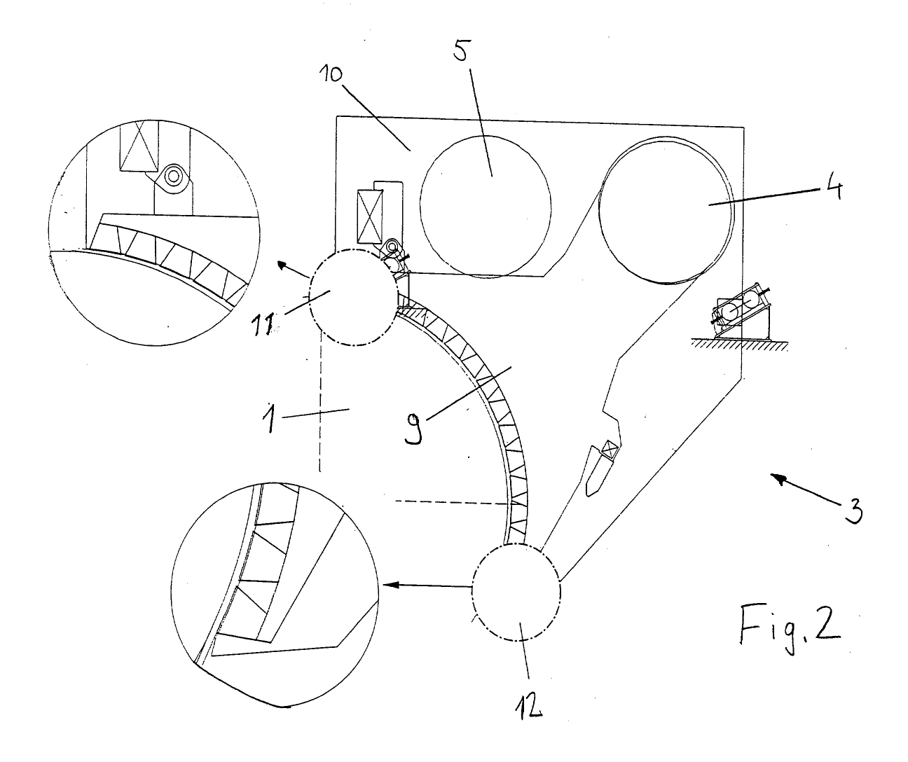

FIG. 2 shows the second hood half 3 of a dryer system. Hot air duct 4 leads into nozzle basket 9 and, through a number of nozzles, flows onto the paper running around the dryer cylinder 1. Hood frame 10 surrounds the nozzle basket 9. As used herein, “hood” should be understood as including structures rigidly connected to the overall hood frame. When nozzle basket 9 and hood structure 10 are in a cold state, the gap at the crown 11 of the hood is smaller than the gap at the hood end 12, in order to achieve the best possible gap between the hood and the cylinder in operation.

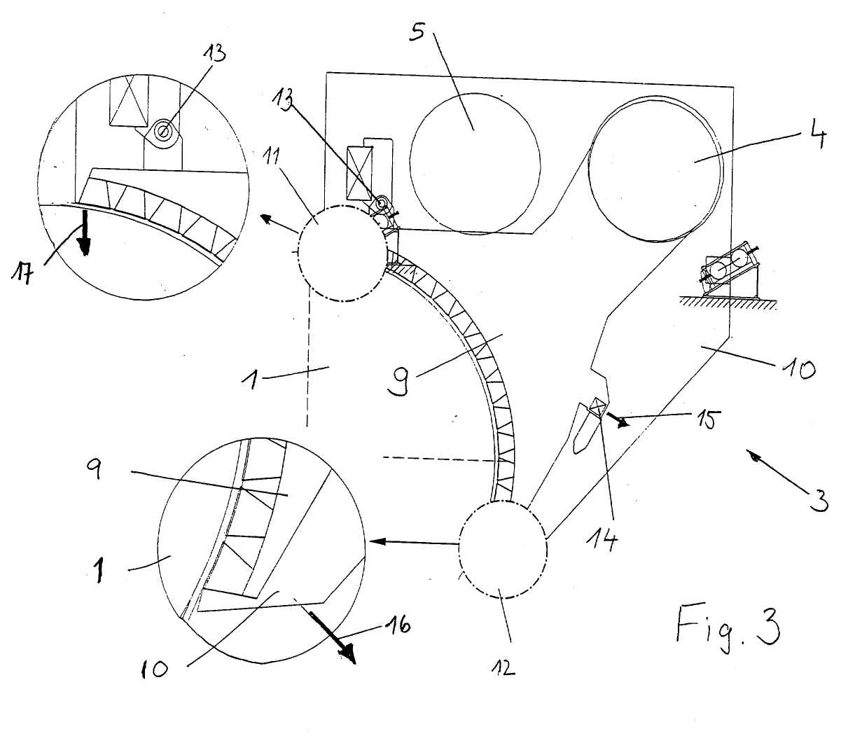

The expansion under heat is shown in FIG. 3, with the nozzle basket 9 during the starting operation being the first to heat up to approx. 600-700° C. The upper limit for this is set by the material qualities of the metal sheets used. To make safe expansion possible and to avoid heat stresses as far as possible, nozzle basket 9 and hood structure 10 are uncoupled according to the invention. In the area of the hood crown 11, nozzle basket 9 is supported pivotably in a bearing 13 at the main support of the hood structure 10. In the lower hood area, nozzle basket 9 glides on a further bearing 14. As a result, the nozzle basket when it is heated moves in the direction of arrows 15 (gliding along bearing 14), along arrow 16 at the lower end 12 in the direction away from cylinder 1 and arrow 17 at the upper end 11 slightly toward cylinder 1.

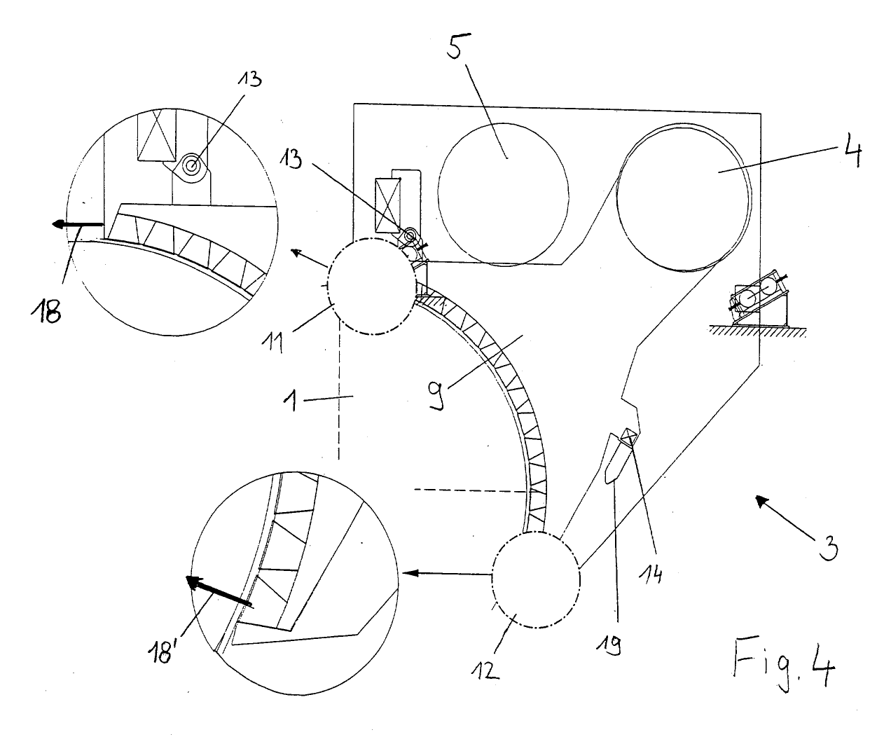

FIG. 4 shows the state in which the hood structure 10 also heats up. The upper bearing 13 is displaced in the direction of arrow 18, i.e. toward the other hood half. This means that the gap between the hood and the cylinder becomes larger again. In the lower area 12, the entire hood half 3 is displaced in direction 18′, so that here the gap recedes. To adjust the gap between the hood and the cylinder optimally, the sliding bearing 14 is arranged slideably and/or adjustably in a slot 19. If a drive is provided here, the gap can be adjusted optimally at any moment in operation.

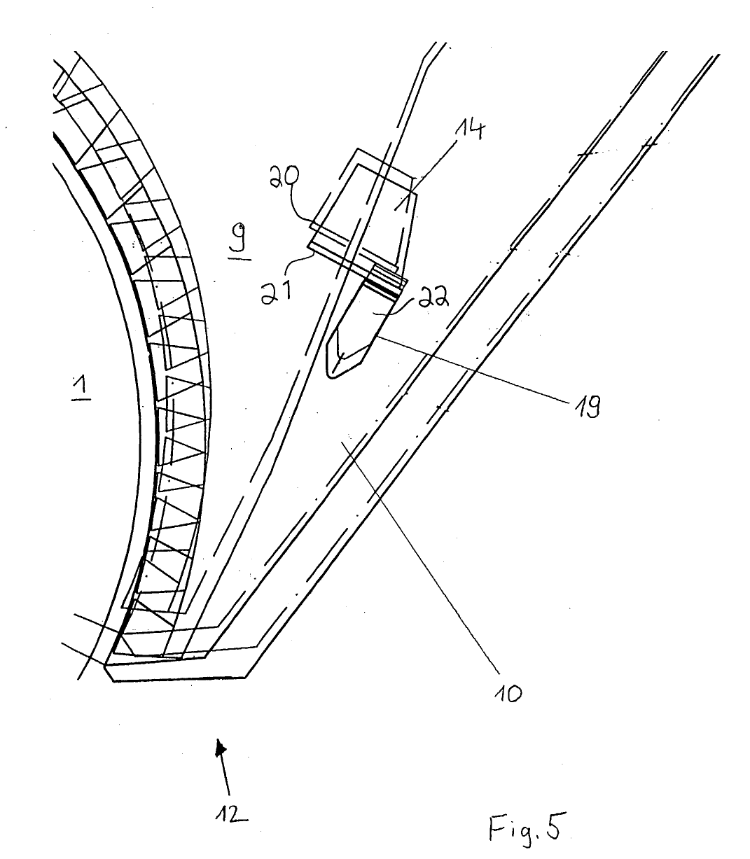

FIG. 5 shows the adjustability in greater detail, with different positions having been entered, which result especially from the expansion under heat. The full lines show the state at operating temperature, while the broken lines show the cold state. The lower bearing 14, which has a sliding design, of the nozzle basket 9, is particularly clearly visible in this figure. Bearing 14 has a lower flange 20 with a flat bottom surface 21 which is slidably carried on support 22 which is slideable and/or adjustable in slot 19.

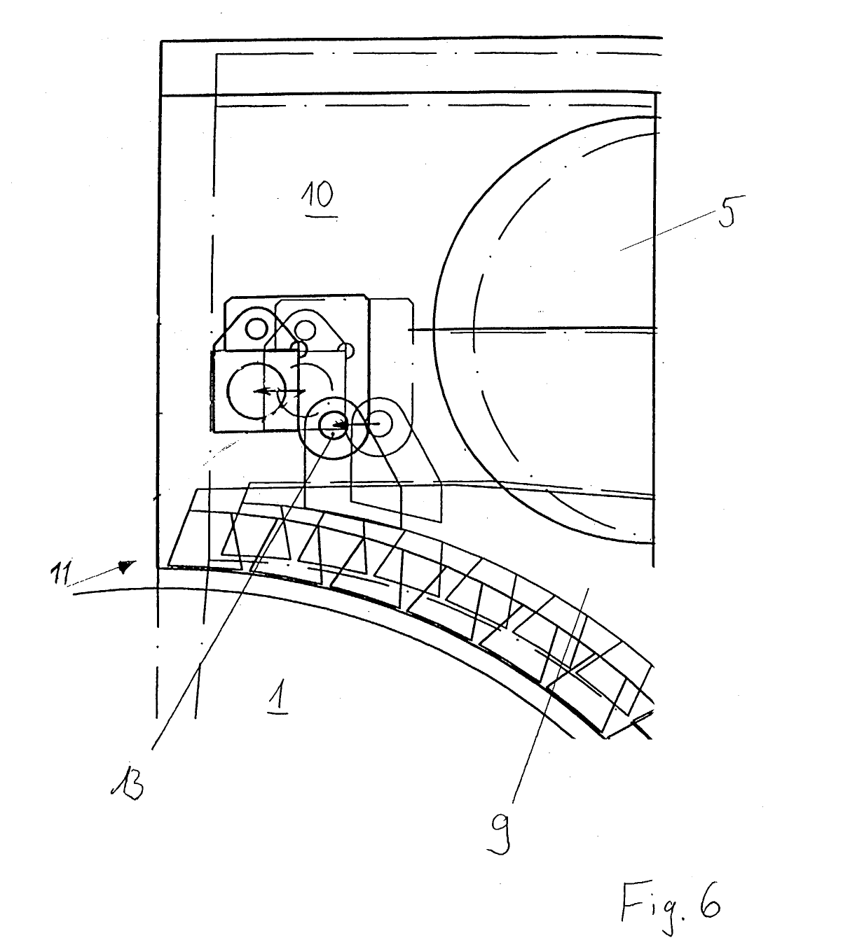

FIG. 6 shows the displacement of the upper bearing 13 on account of the expansion of the hood structure 10 and the displacement in the direction of the cylinder center. Hood structure 10 then draws the nozzle basket 9 along, over the pivotable joint 13. With this construction, the two expansions that act opposite each other are compensated.

As material for the structure, stainless steel (1.4571) or Corten A is normally used. Material giving suitable strength at these elevated temperatures is used for the nozzle basket, for instance 1.4835.

To minimise expansion perpendicular to the paper web, hood structure 10 is fixed on the drive side of the paper machine and nozzle basket 9 is fixed on the front side of the machine. Here also the expansion is minimised because of the fixture at different locations.

1. Device for drying paper webs, especially tissue paper webs, with a dryer cylinder and a dryer hood for blowing hot air onto the paper web, wherein the improvement comprises that the inlet air parts of the dryer hood, such as the nozzle basket or the inlet duct, are uncoupled from the frame or hood structure.

2. Device according to claim 1, wherein the improvement comprises that the nozzle basket is supported pivotable at an upper point in the frame.

3. Device according to claim 1 wherein the improvement comprises that the nozzle basket is supported sliding at a lower point of the hood frame.

4. Device according to claim 3, wherein the improvement comprises that the lower support point is adjustable.

5. Device according to claim 1 wherein the improvement comprises that the frame and the nozzle basket are fixed at opposite drive side and front side perpendicular to the paper web.

6. Device according to claim 1 wherein the improvement comprises a drive unit and a gap sensor being provided for adjustment of the gap between the dryer cylinder and the dryer hood in operation.

7. Device according to claim 1 wherein the improvement comprises the gap between the dryer hood and the dryer cylinder being essentially uniform at all points in operation at high impingement temperatures, especially above 550° C., for instance up to 700° C.

8. Device according to claim 2, wherein the improvement comprises that the nozzle basket is supported sliding at a lower point of the hood frame.

9. Device according to claim 4, wherein the improvement comprises that the nozzle basket is supported sliding at a lower point of the hood frame.

10. Device for drying tissue paper webs, having a dryer cylinder and a dryer hood at least partially enveloping the cylinder, the hood having an inlet duct for receiving an external supply of hot air, an internal nozzle basket in fluid communication with the inlet duct for blowing hot air onto the web as the web is carried on the surface of the cylinder, and an exhaust duct in fluid communication with the nozzle basket for discharging relatively cooler air to the exterior of the hood, wherein the improvement comprises that the inlet duct or the nozzle basket is uncoupled from the hood.

11. Device according to claim 10, wherein the improvement comprises that the uncoupling is a flexible load bearing support.

12. Device according to claim 10, wherein the improvement comprises that the uncoupling is a sliding support.

13. Device according to claim 10, wherein the improvement comprises that the uncoupling is a pivotable connection.

14. Device according to claim 10, wherein the improvement comprises that the nozzle basket is flexibly supported by the frame at a plurality of spaced apart locations on the hood.

15. Device according to claim 10, wherein the improvement comprises that the improvement comprises that the nozzle basket is supported pivotable at an upper point in the frame.

16. Device according to claim 10, wherein the improvement comprises that the nozzle basket is supported sliding at a lower point of the hood frame.

17. Device according to claim 16, wherein the improvement comprises that the lower support point is adjustable.
